(19) United States
(12) Patent Application Publication
(10) Pub. No.: US 2019/0323479 A1
(43) Pub. Date: Oct. 24, 2019

(54) MADSON WIND TURBINE SYSTEM

(71) Applicant: CHARLES MARTIN CHAVEZ MADSON, ILOILO CITY (PH)

(72) Inventor: CHARLES MARTIN CHAVEZ MADSON, ILOILO CITY (PH)

(21) Appl. No.: 16/388,122

(22) Filed: Apr. 18, 2019

Related U.S. Application Data
(63) Continuation of application No. PCT/PH2018/000005, filed on Apr. 24, 2018.

(51) Int. Cl. F03D 1/04; F03D 7/04; F03D 9/17

(52) U.S. Cl. CPC F03D 1/04; F03D 7/041; F05B 2260/42; F05B 2270/32; F03D 9/17

(57) ABSTRACT

The already patented Madson Wind Turbine System (MWTS) embodies a wind turbine system for the collection of wind energy, compression of air (air or gas) in multi-stages to high pressure, for High Pressure—Compressed Air Energy Storage (HP-CAES), decompression of air in multi-stages, cooling of hot compressed air, harvesting of compression heat for heating cold decompressed air to increase volume & air flow for more efficient generation of electricity. This new invention constitutes a significant improvement of MWTS thru improved: ability to resist typhoons, cyclones & hurricanes, harvesting & directing hub area wind to the propellers, streamlining of wind for more efficient use by downstream wind turbines, harvesting of compression heat to heat decompressed cold air, simplification of equipment & construction by reducing the number of or combining the function of components, such as, the functions of transfer & regulator valves in previous inventions for lower capital & maintenance costs & greater efficiency; the introduction of new beneficial components, such as, uncloggable transfer valves; the avoidance of hazards, such as, bird strikes & nuisances, such as, flutter, pulse & vertigo and other improvements for the generation, storage and dispatch of electricity. This improvement also includes an HP-CAES Reserve Tank, constructed with Bolted Joints, such that it can be assembled quickly & cheaply without welding, de-stressing & spherical or thick plates; the elimination of, at least, one (1) built-in derrick and the development of self-regulating controls for feathering the propellers adapted to a Fan Wind Turbines instead of the conventional long aspect ratio sails (propellers).

### BRIEF DESCRIPTION OF THE DRAWINGS

FIG. 1 is a side elevational view of a wind turbine, showing the upper and lower vertical fins, and the horizontal fin;

FIG. 2 is a front elevational view of the wind turbine;

FIG. 3 is a fragmentary cross-sectional view of the wind turbine, taken along its median, elongated axis, showing a portion of the feathering mechanism for the propellers;

FIG. 4 is a fragmentary top plan view of a grouping of three propellers, showing the trim tension bars;

FIG. 5 is a fragmentary side elevational view of a propeller and its associated trim adjustment components;

FIG. 6 is rear elevational view of a grouping of three propellers, showing the trim tension bars and a trim bevel gear;

FIG. 7 is a cross-sectional view of the concentric air reserve tank assembly, taken along a median vertical line;

FIG. 8 is a cross-sectional view of the air reserve tank, taken along a median horizontal line;

FIG. 9 is a fragmentary cross-sectional view, taken to an expanded scale, of the juncture of the upper end plug of the air reserve tank and an assembly of stranded wire ropes;

FIG. 10 is a fragmentary cross-sectional view, taken to an expanded scale, of the juncture of the upper end plug and a tank plate, as well as a transfer valve assembly;

FIG. 11 is a fragmentary cross-sectional view of a dispatch valve;

FIG. 12 is a fragmentary cross-sectional view of an alternative embodiment of the air reserve tank taken along a median vertical line;

FIG. 13 is a fragmentary cross-sectional view of a tank insulator float assembly, used in the air reserve tank of FIG. 12;

FIG. 14 is a side elevational view of a grouping of air turbines and support towers, and the associated guys; and,

FIG. 15 is a top plan view of a matrix of air turbines, showing the guy stay anchors located at strategic positions around the matrix.

### SPECIFICATION

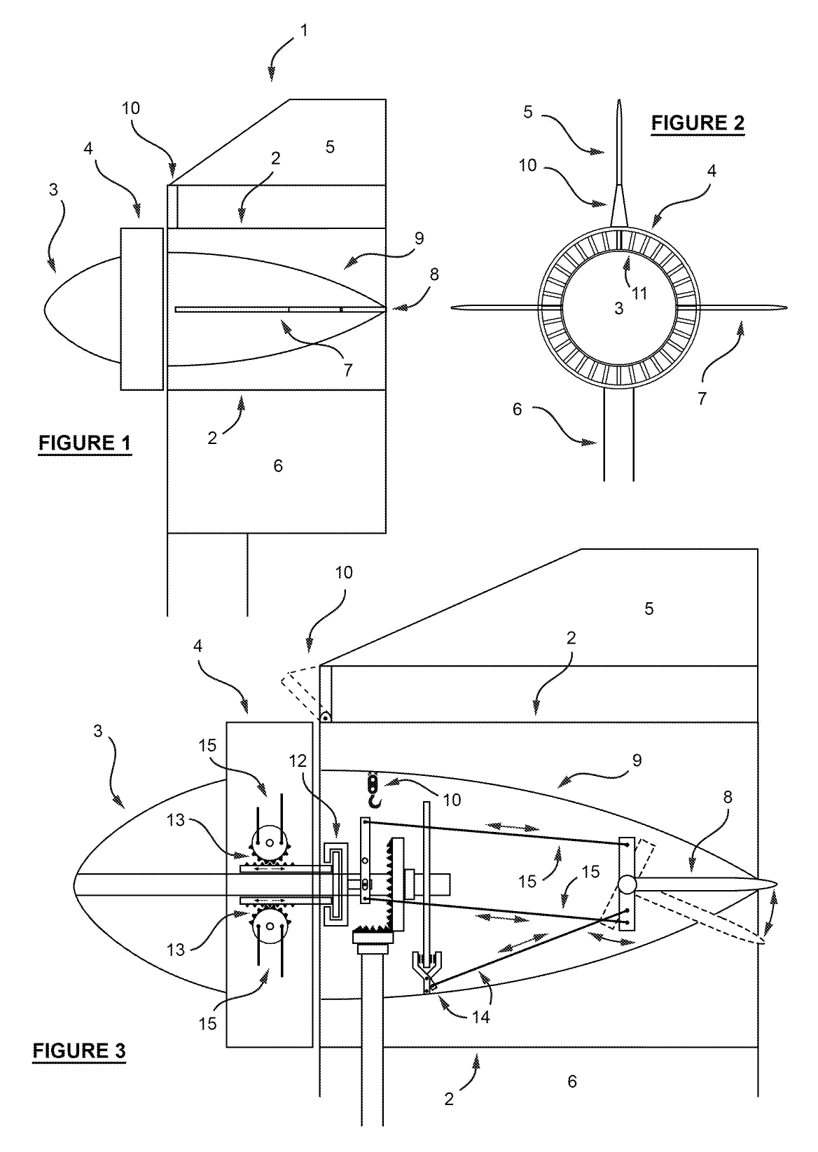

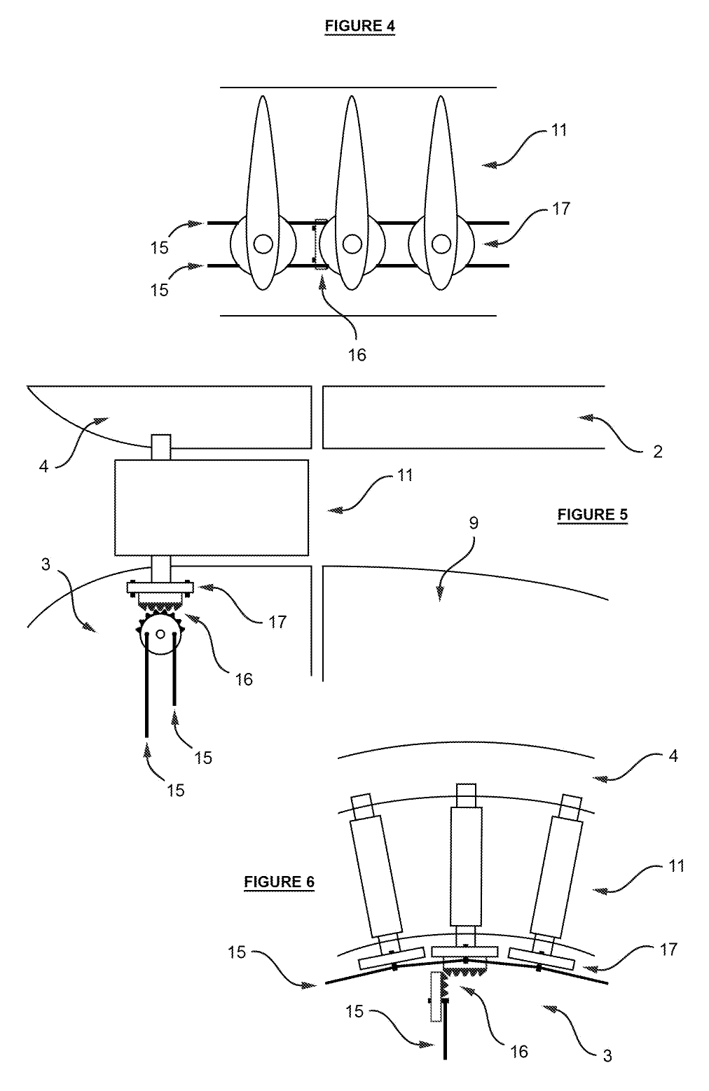

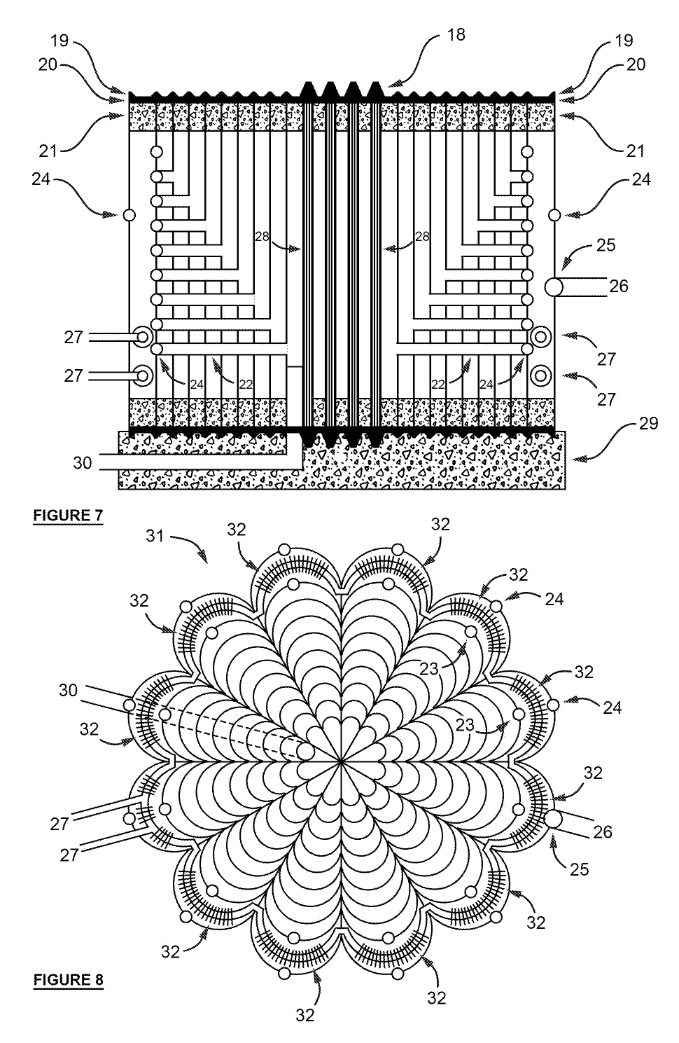

a) This Madson Wind Turbine System (MWTS) improvement provides for a more robust aeronautic (aerodynamic) design (FIGS. 1, 2, 3, 4, 5, 6, 14, 15) having propellers (FIGS. 2, 4, 5, 6) which may be enclosed between a central nose cone & an outer cowling (FIGS. 1, 2, 3, 5, 6) in an aeronautic configuration which is more resistance to storms of up to 250 mpH (400 kpH) in which a nose cone (FIGS. 1, 2, 3, 5, 6) together with a cowling (FIGS. 1, 2, 3, 5, 6) efficiently harvest & direct hub area wind to fan propellers for a stronger wind flow to generate more energy. This MWTS improvement has a more simplified & efficient self-regulating mechanism (FIGS. 3, 4, 5, 6) suited to fan propellers, including a more efficient linkage between the elevator, which moves up & down (FIG. 3), the trim slide mechanism (FIG. 3) & rack & pinion gears (FIG. 3) which move back & forth along the propeller shaft to convey trim actuation by trim tension bars to bevel gears (FIGS. 4, 5, 6) in the nose cone to drive propeller disks (FIGS. 4, 5, 6) which feather propellers (FIGS. 2, 4, 5, 6) up to a fully neutral angle depending on wind strength (FIGS. 1, 2, 3, 4, 5, 6). The elevator (FIGS. 1, 3), Slide Mechanism, Rack & Pinion Gears, Bevel Gears & Propeller Discs are connected & driven by Tension Bars, so that all components act together (FIGS. 3, 4, 5, 6).

b) This MWTS Improvement further provides for nozzle cone with a convex curve (FIGS. 1, 3, 5) to induce a vacuum behind the propellers to drive the propellers more effectively by accelerating the air flow.

c) This MWTS Improvement eliminates, at least, the rear built-in derrick to further reduce cost (FIGS. 1, 3).

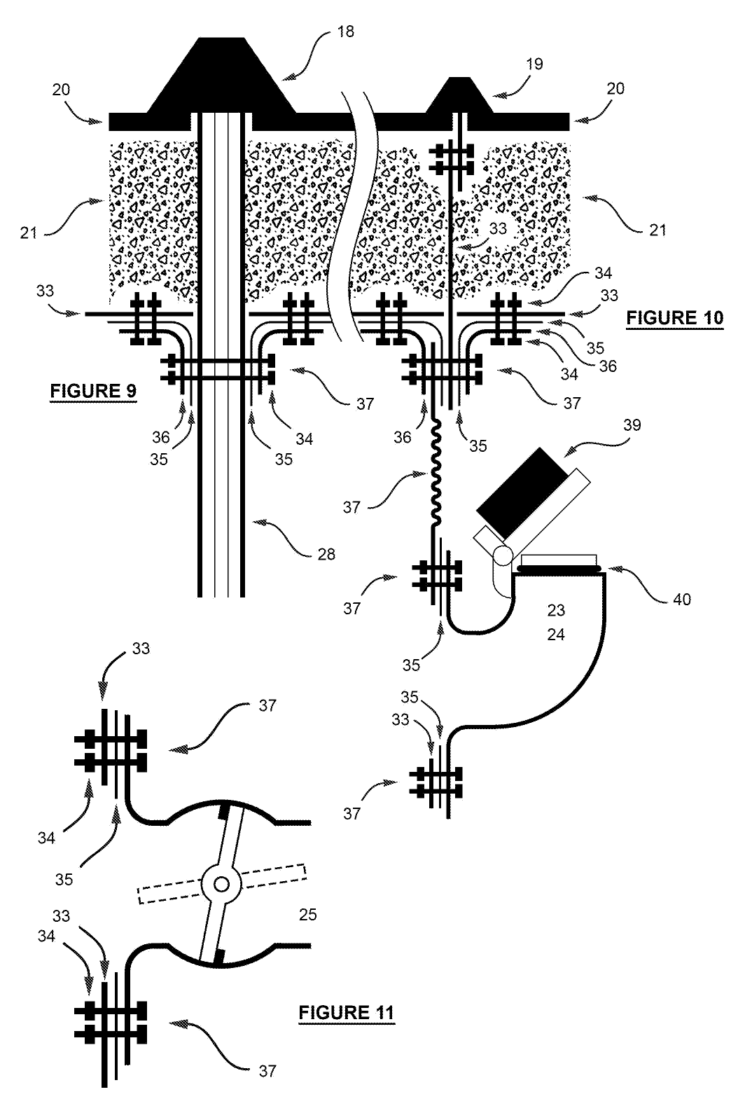

d) This MWTS Improvement provides for High Pressure—Compressed Air Energy Storage (HP-CAES) in Reserve Tanks composed of Concentric Ring Tanks containing graduated pressures with the highest pressure in the Center Ring Tank, the lowest pressure in the Outermost Ring Tank & graduated pressures in the Intermediary Ring Tanks (FIGS. 7, 8). Each Concentric Ring Tank is in turn composed of Catenary Tanks (FIG. 8) to minimize wall thickness, since the wall thickness of a larger tank must increase exponentially compared to the wall thickness of a smaller tank containing the same pressure, which are vertically parallel to each other (FIG. 7). The ends (tops & bottoms) of the HP-CAES Concentric Catenary Ring Tanks (FIG. 7) are closed by flat horizontal tank plates forming square corners with the tank sides (FIGS. 7, 8, 10), which are held in place by reinforced concrete (or other) block plugs (FIGS. 7, 9, 10), in turn held in place by anchors secured by Stranded Wire Ropes (FIGS. 7, 9), which may be pretensioned in pipes stretching from top to bottom of 1 or more Ring Tanks or by anchors secured by the extended tank wall plates (FIGS. 7, 10), whichever, may be necessary according to the pressure in each respective Ring Tank

e) This MWTS Improvement combines the functions of the Transfer Valves & Regulator Valves (FIGS. 7, 8, 10) such that Ring Tank 1 (Outermost) is in direct communication with each of Ring Tanks 10 (Center), 9, 8, 7, 6, 5, 4, 3, & 2 by means of Bypass Lines thru Transfer Valves which are graduated to maintain a pressure differential between adjacent Ring Tanks, such that the highest pressure is in Ring Tank 10 (Center) & the pressures are reduced in graduated stages to the Outer Ring Tank in a way that each Ring Tank need support a pressure differential which may be only about 300 PSI, to Ring Tank 1 from which the air is dispatched to air turbines which drive generators for electricity generation (FIGS. 7, 8, 11).

f) This MWTS Improvement provides for Uncloggable Transfer Valves (FIGS. 7, 8, 10) wherein the valve lid (with a hinge on one side) closes against a soft seal & opens radially on the hinge, such that, as the differential pressure from the inner tank increases, the lid begins to rotate & detach incrementally from the soft seal before any chance of freeze-up, after which the lid opens as much as required by the air flow driven by the total pressure differential.

g) This MWTS Improvement provides for Dispatch Valves (FIGS. 7, 8, 11), which may be Butterfly Valves, such that pressurized air may be released in seconds for the immediate dispatch of electric power.

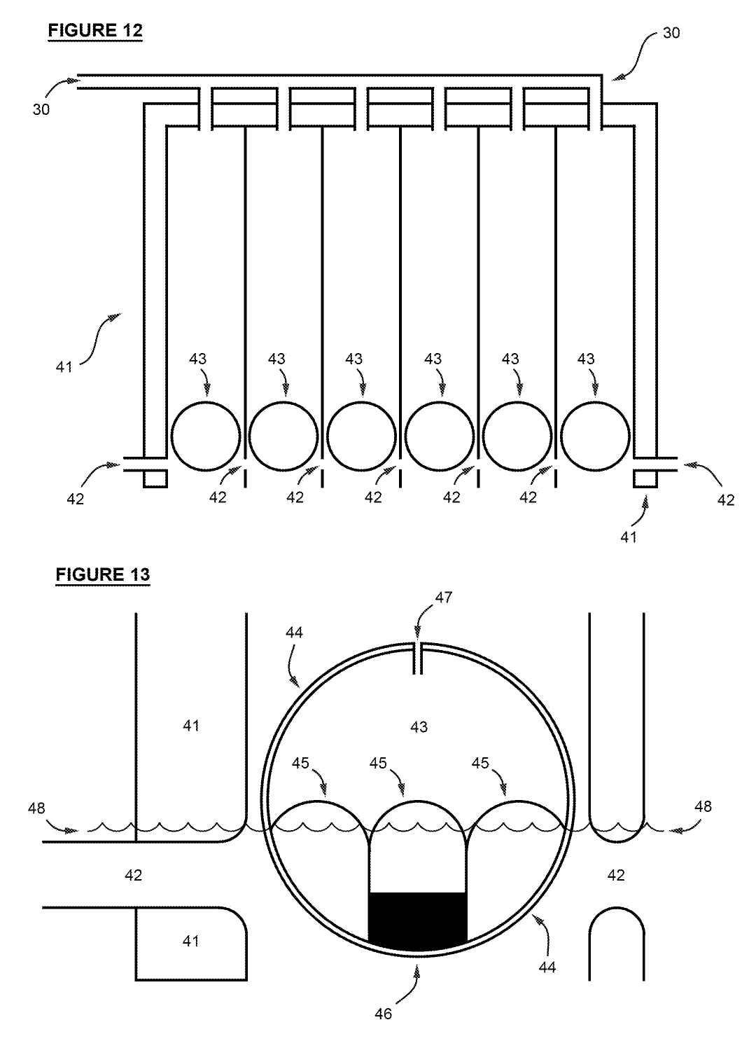

h) This MWTS Improvement provides for an Underwater Reserve Tank System (FIGS. 12, 13) in which compressed air, as it is produced, is received directly from the high pressure stages of the Wind Turbines, at the top (FIG. 12) & forced down large Storage Tubes, pushing down the water level in the Storage Tubes according to the pressure delivered (FIGS. 12, 13). The heat from compression is preserved by insulating the top & sides of the Underwater Reserve Tank System, while the hot air in the Storage Tubes is insulated from the cold water at the bottom by Insulator Floats (FIGS. 12, 13), which rise & fall with the water level.

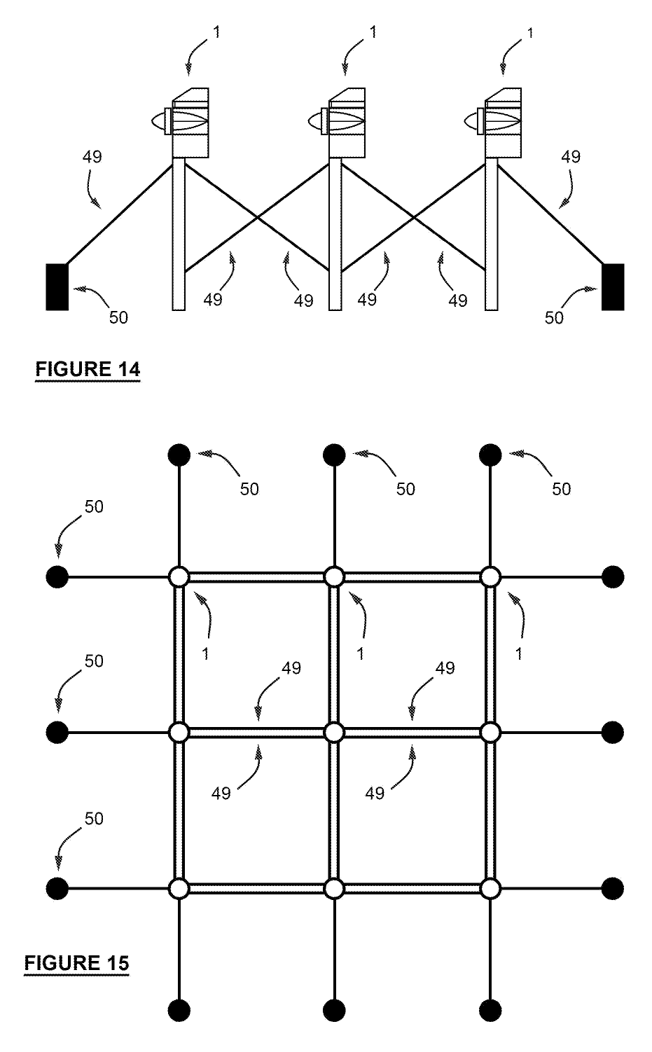

i) This MWTS Improvement provides for bracing & anchoring the Land Based Wind Turbines by means of Guy Stays & Guy Stay Anchors (FIGS. 14. 15).

PARTS LEGEND:

1. AERONAUTIC WIND TURBINE

2. NACELLE

3. NOSE CONE

4. COWLING

5. UPPER VERTICAL FIN

6. LOWER VERTICAL FIN

7. HORIZONTAL FIN

8. ELEVATOR

9. NOZZLE CONE

10. BUILT-IN DERRICKS

11. PROPELLERS

12. TRIM SLIDE MECHANISM

13. TRIM RACK & PINION GEARS

14. BRAKE & TENSION BAR

15. TRIM TENSION BARS

16. TRIM BEVEL GEARS

17. PROPELLER DISCS

18. STRANDED WIRE ROPE ANCHORS

19. TANK WALL ANCHORS

20. TANK ANCHOR BEAMS

21. TANK END PLUGS

22. BYPASS LINES

23. UNCLOGGABLE TRANSFER VALVES

24. TRANSFER RELIEF VALVES

25. DISPATCH VALVES

26. OUTLET PIPES

27. HEAT EXCHANGER

28. STRANDED WIRE ROPES (IN PIPE)

29. FOUNDATION

30. INLET HP-CAES PIPE

31. CONCENTRIC RESERVE TANKS

32. CATENARY SIDED RESERVE TANKS

33. TANK PLATES

34. TANK JOINT BOLTS

35. TANK JOINT GASKETS

36. TANK JOINT ANGLE BRACKETS

37. TANK BOLTED JOINTS

38. TANK FLEXION PANEL

39. TRANSFER VALVE GRADUATED WEIGHT

40. TRANSFER VALVE SEAL RING

41. INSULTED TANK SIDES (WATER BASED)

42. RESERVE TANK RELIEF OUTLETS

43. RESERVE TANK INSULATOR FLOATS

44. TANK INSULATOR FLOAT FRAME

45. TANK INSULATOR FLOAT BLADDERS

46. TANK INSULATOR FLOAT BALLAST

47. TANK INSULATOR RELIEF OUTLET

48. WATER LEVEL

49. GUY STAYS (LAND BASED)

50. GUY STAY ANCHORS

1. This invention provides for aeronautic & robust Fan Wind Turbines which can survive typhoons, cyclones & hurricanes of up to 250 mpH (400 kpH) (strongest on record, not including tornados) by virtue of the aeronautic design, robust construction, low aspect ratio & fully neutral featherability of propeller blades (FIGS. 1, 2, 3, 4, 5, 6, 14) and Guy Stays & Guy Anchors (FIGS. 14, 15). This level of durability is not enjoyed by large capacity wind turbines with large aspect ratio sails (propellers) of the current state-of-the-art.

2. This invention provides an autonomous self-regulating control system by means of an elevator, which moves up & down (in relation to wind speed) on the trailing edge of a horizontal fin to trim or fully feather propeller blades thru levers, tension bars, slide mechanism, rack & pinion gears, bevel gears & propeller discs (FIGS. 1, 2, 3, 4, 5, 6, 14), which are adapted to the control of the Propellers in a Fan Wind Turbine (FIGS. 3, 4, 5, 6)

3. This invention provides for Built-in Derricks for self-erection of the heavy components, such as, the propeller without the need for heavy construction cranes. Furthermore, all the heavy components present in the nacelles at the top of the current state-of-the art large wind turbines have been eliminated or moved to the base (FIGS. 1, 2, 3).

4. This invention provides for a square-cornered, concentric, catenary-sided HP-CAES Reserve Tank System with a Bolted Joint Tank design (FIGS. 7, 8, 9, 10), which makes possible the rapid & economical construction of a manageably sized vessel capable of containing a sufficiently large volume of sufficiently high pressure air to store enough energy for grid or industrial applications in a manner that eliminates: welding, stress relief, spherically dished plates or excessively thick tank walls. This invention needs only thin rolled steel plates (using only two dimension bending) which are easy & economical to produce (not three dimensional dishing).

5. This invention provides for combining the functions of the Transfer Valves & Regulator Valves used in previous MWTS inventions in order to drastically reduce the total number of valves, while maintaining all the benefits of both the Transfer Valves & the Regulator Valves used previously. The new invention uses Transfer Valves alone with graduated weights to provide the pressure differentials between ring tanks while still allowing the extraction of inner tank high pressure air during periods of wind quiescence and without having Regulator Valves exposed to the outside.

6. This invention provides for Dispatch Valves (FIGS. 7, 8, 11), which may be Butterfly Valves, such that pressurized air may be released in seconds for the immediate dispatch of electric power.

7. This invention provides for an Underwater HP-CAES System which may receive high pressure air directly from the high pressure stages of the wind turbines into submerged vertical tubes at depths which utilize high water pressure to contain high air pressure, thereby, minimizing the structure needed to contain the high air pressure, while at the same time preserving the heat of the highly compressed air.
